(19) United States
(12) Patent Application Publication
(10) Pub. No.: US 2007/0009393 A1
(43) Pub. Date: Jan. 11, 2007

(54) Efficient microfluidic devices

(76) Inventors: Marten Bergstrom, Uppsala (SE); Lars-Goran Larsson, Knivsta (SE); Robert Bielik, Balinge (SE); Lars Salomonsson, Uppsala (SE)

Correspondence Address: FULBRIGHT & JAWORSKI, LLP, 1301 MCKINNEY, SUITE 5100, HOUSTON, TX, 77010-3095, US

(21) Appl. No.: 11/522,170

(22) Filed: Sep. 15, 2006

Related U.S. Application Data
(62) Division of application No. 10/403,615, filed on Mar. 31, 2003.
(60) Provisional application No. 60/370,906, filed on Apr. 8, 2002.

(30) Foreign Application Priority Data
Mar. 31, 2002 (SE) SE-0201006-4

(51) Int. Cl. B01L 3/00

(52) U.S. Cl. 422/100

(57) ABSTRACT

A microfluidic device having a plurality of microchannel structures and a memory. The memory may be writeable with restriction for unauthorized access. Yet further, the memory can be information about positions of non-redundant or redundant microchannel, information relating to positions for interfacing the microchannel structures with the macroworld, or supplemental information relating to process protocols that are allowed for the microchannel structures of the device.

This application is a Divisional Application of U.S. application Ser. No. 10/403,615 filed Mar. 31, 2002 that claims priority to Swedish application No. SE-0201006-4 filed on Mar. 31, 2002 and U.S. Provisional Application Ser. No. 60/370,906 filed Apr. 8, 2002, which are incorporated herein by reference.

### BACKGROUND OF THE INVENTION

I. Field of Invention

Generally, the present invention relates to microfluidic devices. More specifically, the microfluidic device comprises a memory. The memory may be writeable with restriction for unauthorized access. In certain aspects, the memory can be information about positions of non-redundant or redundant microchannel, information relating to positions for interfacing the microchannel structures with the macroworld, or supplemental information relating to kind of process protocols that are allowed for the microchannels.

II. Related Art

A. Background Publication

WO 97 21090 (Gamera Biosciences) describes among others systems in which the device comprises a memory that may comprise an electromagnetically-readable instruction set for controlling rotational speed, duration, or direction of the device. The text gives other kinds of on-board information and memories. The memory may be a read-only-memory or a random-access-memory. Communication between the disc and the corresponding instrument is by various means. See also U.S. Pat. No. 6,030,581 (Burstein Laboratories).

WO 9957310 (Biochip Technologies) describes a microfluidic biochip, which has one microchannel structure in which there may be a number of matrix spots placed along the structure. Each of the spots carries a particular reagent. Spots that have the same reagent/matrix composition are said to be redundant and used in parallel to increase the reliability in a result obtained. Certain kinds of user-related information can be stored on the biochip in a memory.

WO 02059625 (Weigl et al) describes a microfluidic device, which comprises a microelectronic chip for controlling specific functions on the device and an antenna for receiving radio energy which is then transformed to electrical power for operating electrical components on the device. Specific functions of the chip comprises providing identification of the device, calibration information to an external readout device, measuring of chemical or optical parameters, and manufacturing parameters (e.g., channel depth, optical window transmission).

U.S. Pat. No. 6,495,104 (Caliper Technologies) describes a microfluidic device comprising an indicator element that is fabricated into the body structure of the device, provides an indication of the functionality of the device (including used or not used), and is selected amongst electrical, mechanical, optical, and/or chemical indicator elements.

B. Background Technology and Problems

The inter-channel variations of physical and chemical features of the microchannel structures in a microfluidic device have to be minute in order to facilitate good reproducibility and reliability of the results obtained. The variations may originate from a) the fabrication of the microchannel structures as such, b) chemical and physical modifications in post fabrication steps, or c) improper handling by the user, etc.

Typically, the manufacturing [items a) and b)] comprises a large number of steps, each of which has a certain yield that in most cases is below 100%. This means that it will be difficult to manage with a high total yield of microfluidic devices in which all microchannel structures meet preset quality criteria. The non-acceptable structures will appear randomly in the devices meaning that their number as well as positions will vary between microfluidic devices. The presence of non-acceptable structures will be a disadvantage that has to be minimized. By withdrawing microfluidic devices comprising a non-acceptable microchannel structure from sale, the yield in the manufacturing process will easily be unacceptable. On the other hand, the offering of microfluidic devices comprising non-acceptable microchannel structures to customers may turn out negative from the manufacturer-customer's perspective.

It is also important to align external detection means, dispensation means and the like with their receiving structures on a device with a high accuracy. As will be discussed below there is a significant risk that the manufacturing process may cause unacceptable inter-device variations in the positioning of inlet ports, detection windows, etc.

The present invention is the first to develop a microfluidic device to address these issues. Thus, the present invention provides a device that prevents customers from using non-acceptable microchannel structures in devices that comprises both acceptable and non-acceptable microchannel structures. Yet further, the present invention also provides a device that has specific correction information attached to the individual devices. Still further, the present invention provides a device that contains specific process variables in order to supplement process protocols provided by software that is allocated elsewhere in the system.

### BRIEF SUMMARY OF THE INVENTION

The present invention relates to a microfluidic device in which the device has been optimized to increase the amount of usable or acceptable microchannel structures. The microfluidic device of the present invention contains a plurality of microchannels and memory. The memory of the microfluidic device may be writeable with restriction means for unauthorized access.

In specific embodiments, the memory can contain information about locations of microchannel structures to be used (non-redundant structures) and/or not to be used (redundant structures), and/or approved (=acceptable) and/or disapproved (=non-acceptable) microchannel structures. Specifically, the information relating to the positions of redundant or non-redundant microchannel structures may result in a microfluidic device having a plurality of microchannel structures with a redundancy that is ≦50%.

In further embodiments, memory can contain information relating to positions for interfacing of the microchannel structures with the macroworld. Still further, the memory can contain supplemental information relating to process protocols that are allowed for the microchannel structures. It is envisioned that the memory contains at least one type of information (e.g., information about locations of microchannel structures to be used and/or not used and/or approved or disapproved microchannel structures; information about positions for interfacing; or supplemental information relating to process protocols) or the memory can contain two types or all three types of memory.

Another embodiment of the present invention is to increase the yield of successful runs of a certain protocol in relation to the number of microfluidic devices or microchannel structures used.

Yet further, another embodiment is to provide a microfluidic device that comprises redundant microchannel structures, i.e. one or more microchannel structures that are not intended to be used and in principle are the same as other microchannel structures of the device.

Still further, another embodiment is to restrict inefficient use of a microfluidic device which may lead to poor result and the like.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 illustrates a circular microfluidic device (11) with 100 microchannel structures (12) and a square-shaped radiofrequency identification (13) (RFID or transponder). Each microchannel structure has a sample inlet (14) and sample outlet (15) and therebetween a reaction microcavity (16) that in this case is a nl-column. There are also inlets (17) each of which is common for 10 microchannel structures. The device has 4 redundant structures. Thus, the device shown is intended for at maximum 96 samples, which corresponds to the number of samples in a conventional microtitre plate. The device shown has a axis of symmetry (18, spinning axis) and a home mark (19).

FIG. 2 illustrates the same microfluidic device with an annular-shaped transponder (23).

### DETAILED DESCRIPTION OF THE INVENTION

I. Definitions

As used herein, the use of the word “a” or “an” when used in conjunction with the term “comprising” in the sentences and/or the specification may mean “one,” but it is also consistent with the meaning of “one or more,” “at least one,” and “one or more than one.”

As used herein, the expression “information about location and/or position” of microchannel structures comprises: position coordinates that enable dispensation to liquid inlets, detection in detection microcavities etc of microfluidic devices.

As used herein, the term “redundant microchannel structures” in the context of the present invention means excess structures that are not to be used. This is contrary to the redundant spots of WO 9957310 (Biochip Technologies) that intentionally are placed such that they have to be used.

As used herein, the term “non-redundant microchannel structures” in the context of the present invention means structures that are to be used.

As used herein, the term “dedicated” means that the microfluidic device, the instrument and/or the software can be used together, preferably in the same system.

As used herein, the term “software” includes both logics and memories.

As used herein, the term “memory” is readable without exclusion of also being writeable. Different kinds of memories are well known in the field, for instance read-only-memory (ROM), and random-access-memory (RAM). Both terms are used generically in the context of the invention.

As used herein, the term “microfluidic device” means a device that comprises a plurality of enclosed microchannel structures. These microchannel structures are used for transporting and processing liquid aliquots that are in the microliter range and may contain reactants including e.g., analytes and reagents.

As used herein, the term “microchannel structure” typically comprises microchannels with depths and/or widths that are ≦1,000 μm, such as ≦500 μm ≦200 μm or ≦100 μm or ≦50 μm. In addition to microchannels for transport of liquids, there may also be separate channels that vent to ambient atmosphere, either for inlet or outlet of air. The widths and/or depths of venting channels may be in the same range as the other channels, but many times it may be advantageous to make them more narrow and/or more shallow than the channels used for liquid transportation (e.g., with width and/or depths ≦500 μm ≦200 μm or ≦100 μm or ≦50 μm).

As used herein, the term “a plurality of microchannel structures” means two, three or more microchannel structures. Typically the term “plurality” means ≧10, such ≧25 or ≧50 or ≧90 or ≧180 or ≧270.

As used herein, the term “macroworld” refers to outside the microchannel structures/device.

As used herein, the term “supplemental information” refers to information that is used to amend or alter process protocols that are provided by the system used to process the innovative microfluidic device.

As used herein, the term “blocking” refers to stopping or ceasing the use of the device and/or individual microchannel structures. For example, the memory can contain information that prohibits the usage of the device after a certain date and/or individual microchannel structures such as redundant or disapproved microchannel structures. Yet further, if the memory is writeable, the writeable memory information can be changed, for instance by the system, to prevent further use of a microchannel structure after its first use.

II. Memories

Memories may be readable by radiation (including laser light, etc.), electric current, etc. The same means may not necessarily be used for both reading and writing, for instance a memory readable by an electrical current is typically also writeable by an electric current, and a memory readable by optical means is typically not writeable by the same kind of optical means. Memories that are readable by radiation are named optical memories and may be mechanical. Bar codes and conventional CDs are examples of optical memories. Memories that are readable by electric current are examples of electronic memories.

The communication between a device and a dedicated instrument may in principle be by any means provided the memory and the communication means are adapted to each other for a correct and safe transfer of information from the memory to the dedicated instrument and vice versa if the memory also is writeable.

The means for communication between the instrument and the memory of the disc may be illustrated by electromagnetic means, such as laser light, infra-red light, radio waves, microwaves, electric current, etc. Typically, the means used utilizes a sender/receiver on the device and/or on the instrument.

In certain variants of the present invention, the means used for communication can directly collect information from the memory of the device and transfer it to the instrument. In these variants, the sender/receiver on the device is an integral part of the memory, for instance a laser readable memory.

In other variants of the present invention, the communication means has to be transformed by a microprocessor on the device to a signal that can be used for collecting information from the memory. This signal with the collected information is then retransformed to the signal used for communication and sent back to the instrument. A typical case is to use radio waves from a sender on the instrument. The radio waves are received via an antenna and transformed in the microprocessor on the device to an electrical current that then collects the information from the memory. After retransformation of the signal by the microprocessor on the device, the signal is returned to a receiver on the instrument where it is further processed. Similarly, information can be transferred from the instrument to the memory on the device, e.g. for blocking individual microchannel structures or the complete device. A chip containing a memory, an antenna and a microprocessor is called a radio frequency identification (RFID) or transponder. In these variants, the sender/receiver on the device is distinguishable from the memory.

In specific aspects of the invention, a writeable memory typically comprises a restriction that prevents unauthorized writing in the memory (i.e. allows with exclusivity authorized writing). The restriction may be in the form of a code, or some other means that renders it difficult for unauthorized individuals to change in the memory. Typical such other means are that the information as such and/or the position of various types of information in the memory are encrypted. Authorized use is typically by the system to which the device belongs, or by the manufacturer of the system or his representative. Unauthorized use may be by the customer. Different individuals may be authorized to use different parts of the memory. The system, the manufacturer or his representative, and the user are examples of individuals.

The location of the memory on a microfluidic device is discussed under the heading “Microfluidic Device” below.

III. INNOVATIVE CONTENT OF THE MEMORY

A. Approved/disapproved and non-redundant/redundant structures

This aspect of the invention relates to the microchannel structures on a microfluidic device being categorized in relation to preset quality criteria based on how the structures would work when used in an intended kind of process protocol. Typically only two grades are needed: acceptable=approved, and non-acceptable=disapproved. The structures are then divided into two groups: a) structures intended to be used (non-redundant), and b) structures intended not to be used (redundant). The non-redundant group contains a predetermined number of microchannel structures that are approved and no disapproved microchannel structures. The redundant group contains the microchannel structures that are disapproved plus any remaining microchannel structures that are approved. The predetermined number referred to depends among others on the desired yield of the production of the microfluidic device and the lowest ratio of approved microchannel structures per devices in which this yield corresponds. The number of disapproved microchannel structures in the redundant group may thus vary between none and all for devices of a particular kind.

In an alternative variant, the redundant microchannel structures always are disapproved structures, i.e. the portion of redundant structures varies between devices of the same kind and depends on the outcome of the manufacture of the particular device. Similar variants in which the ratio disapproved structures/redundant structures is constant can also be envisaged.

The redundancy is the ratio between the number of redundant microchannel structures and the total number of microchannel structures of a device. The goal is to have a redundancy in percentage in the innovative microfluidic device that is 0% or as close as possible to 0%, for instance ≦50%, such as ≦20% or ≦10% or ≦5% or ≦1%. The same ranges apply to the percentage ratio of disapproved structures, with the provision that the percentage of disapproved structures must be≦redundancy.

A redundancy of 0% means that all microchannel structures are to be used for a particular kind of protocol. An alternative terminology is that there is a lack of redundancy for the microchannel structures concerned.

By the proper design of the software of the system, non-acceptable structures and/or redundant structures may be blocked from use by properly labeling the memory. The manufacturer typically makes this blocking and may also insert restriction means that have to be overcome by unauthorized individuals to open blocked microchannel structures, e.g., by inserting a security code and/or security check and/or encryption as discussed above. Alternatively, the user is instructed by the system or by manuals not to use or to block redundant and/or disapproved structures. In a typical variant, there is a free-to use label on approved and non-redundant microchannel structures while redundant and disapproved structures are blocked from being used.

In the case the device comprises two or more kinds of microchannel structures and each kind is intended for a particular type of process protocol, the categorization above into non-redundant/redundant and/or approved/disapproved structures may be linked to a particular kind of process protocol.

B. Positions used for interfacing of microchannel structures with the macroworld

Interfacing between a microchannel structure and the macroworld requires information about the interfacing positions on the device. Typical interfacing operations are dispensation to inlet ports, detecting via detection areas, connecting electrical current via connectors, heating by irradiation via heating windows, etc.

Positions used for the interfacing operations are typically given as coordinates relative to one, two or more reference points or marks within the device, for instance as conventional x;y-coordinates or as a radial and an angular coordinate. The latter variant is typically applied to disc-like devices that are spinnable or rotatable with the reference points (marks) being the spin axis, e.g. the center of the disc (intersection of the spinning axis with the disc) and a home mark on a spinning/rotating part of the disc. The home mark preferably is associated with or close to the periphery of the disc.

There are mainly two kinds of position information: i) basic position information which is common for devices of the same kind, and ii) other position information which reflects variations between devices of the same kind. The term “kind” in this context primarily means that the number, design and/or arrangement of microchannel structures are essentially the same in the individual microfluidic devices.

1. Basic position information (type (i)):

This information is of general character and typically relates to all devices of a certain kind irrespective of batch. It is typically included in a memory that is outside the device, but may also be included in the memory on the device.

2. Other position information (type (ii)):

This kind of information primarily refers to variations in the position coordinates created during the manufacturing. The information may be more or less specific for the individual devices and is therefore preferably located to the memory on the individual devices.

Variations in position co-ordinates created during the manufacturing process may depend on changes in the volume of the material in which the microchannel structures are fabricated. It may also depend on uncertainties in placing the reference marks on a device.

A particular problem that is related to type (ii) information may occur when the microchannel structures together with one, two or more reference mark structures are fabricated in a substrate by replication from a master matrix comprising the inverse of the various structures. The positions of the inverse microchannel structures are typically well defined relative to the inverse reference mark structure in the master matrix. However, it has turned out that disturbing variations in distances and volumes may be produced during the replication process, and that these variations depend on the process variables used including the material in the replicas etc. This kind of variation is many times pronounced for replicas in plastics with the typical change in distances being a shrinkage compared to the master matrix. The change is called “material factor” or when only shrinkage is concerned “shrinkage factor”. The factor may be represented as a percentage change in volume. For devices intended for spinning/rotating utilizing radial and angular coordinates for defining positions, the material factor will primarily affect the radial coordinate.

With respect to the problem described in the previous paragraph, one variant of the invention is that the memory on the device contains the material factor with the basic position information placed in a memory outside the device. Another variant is that the basic position information adapted with due account taken for the material factor is placed in the memory on the device. Basic position information in these variants may refer to the position coordinates for the corresponding structures in the master matrix or in the master used for producing the master matrix.

The variants given in the previous paragraph may be particularly useful for devices that are made in transparent material.

Another problem may occur when a reference mark (home mark) is added after the microchannel structures have been introduced. In this case, the uncertainty in positioning of the reference mark on the device may be reflected in significant variations between the devices. This means that in principle the memory in each device needs to be provided with the actual deviation (type (ii)) from the basic position coordinate(s) of the reference mark (=type (i) information that is common for several devices). This can be accomplished in a number of ways: a) placing the basic position coordinate(s) and the deviation in the memory on the device, b) placing the deviation in a memory on the device and the basic position coordinate(s) in a memory elsewhere in the system, etc.

The previous variant may be particularly useful for devices that are made in non-transparent material.

Problems with positioning may also relate to post-assembly processing, for instance introduction of material necessary for the use of a device may not be positioned in the microchannel structures with the sufficient accuracy. A typical case is the introduction of separation material as a packed bed of particles or as a monolith. Often there will be a variation in bed length within as well as between devices. In this case information such as length and/or position co-ordinates defining the extension of the bed for each individual microchannel structure is added in the appropriate location of the memory on the device. Exact bed extension may be important if a molecular entity is to be measured directly in the bed. The information may also be external to the device as discussed in the previous paragraph.

C. User-related information

This kind of information is primarily related to actions performed by the user and therefore needs a writeable memory in which the user and/or the system can modify information inserted by the manufacturer. Such information is unused/used for the device and/or for the individual microchannel structures. Other user-related information includes within/outside the recommended shelf life. Similar functions may be inserted relative to other kind of actions that the manufacturer regards as harmful. Another kind of user-related information is that the memory on the device has space for storing information about different process step that has been performed within the device and/or within the individual microchannel structures.

The information added by the user and/or by the system may or may not restrict the use or reuse of the device and/or individual microchannel structures. Typically, blocking is combined with difficulties for unauthorized individuals to reopen and use the device and/or the microchannel structures concerned (security codes). Difficulties with reopening are primarily designated to blocking made by the system.

D. Suppkemental information relating to processes

This kind of information relates to process variables such as volumes of liquid aliquots to be dispensed to inlet ports, liquid flow rates (for instance spinning speeds and times if the device is rotatable), temperatures, reagents, incubation times for particular steps, detection principles, washing solutions, conditioning conditions, etc. The information includes addition, replacing, altering and removal of process steps including also particular values of the variables and presumes that the complete process protocol or the part thereof in which a change is to be made already is provided through the system.

Typically, this information, if present on the device, is checked against the process portocol provided through the system. Such protocols may be newly designed by the user or fully or partly provided by the manufacturer via the system. See for instance WO 303025585 (Gyros AB), which is incorporated by reference. If appropriate the system will change the variables in the protocols or vice versa automatically. Alternatively the user instructs the system.

Other information

The memory on the device may also comprise other information such as production date, device type, batch number, disc identification number, complete process protocols, etc. This kind of information may be readable by the system and checked for acceptance of the particular device.

IV. THE MICROFLUIDIC DEVICE

The microfluidic devices are well known in the field. See for instance discussion about background technology/publications in WO 02074438 (Gyros AB). Microfluidic devices may have different forms. During the last years disc-like shapes have become of utmost interest.

A microfluidic device comprises a plurality of microchannel structures, each of which is intended for carrying out processing of one or more liquid aliquots, for instance for analytical and/or preparative purposes. These aliquots are dispensed to one or more inlet ports of each of one or more of the microchannel structures in which the aliquots then are transported and processed in substructures that are present at predetermined positions. Typical substructures are inlet ports, reaction microcavities, mixing microcavities, detection microcavities (often transparent or opening to ambient atmosphere), outlet ports, etc. Inlet and outlet ports are used for the introduction or exit of liquids and/or for inlet of or outlet to ambient atmosphere (vents).

A microfluidic device is typically intended for use in a system that comprises an instrument for handling the device during the processing, and the appropriate computer and software for controlling this handling and processing. The software and/or the accompanying computer is typically physically located to the instrument but may also be remote to but in communication with the instrument. Certain parts of the software may be located on the microfluidic device.

For the inventors, microfluidic devices that have an n-numbered axis of symmetry (Cn) with n being 5, 6, 7 or larger, for instance ∞ (C∞) have been of particular interest. The main reason has been that if these forms comprise microchannel structures with substructures extending from an upstream inner part to a downstream outer part, liquid flow can be driven therein by spinning the device around its Cn-axis (spinning axis). In this context, “inner” and “outer” mean that inner is closer to the Cn-axis than outer. Circular, conical, cylindrical and spherical forms are examples of forms that have a Coo-axis of symmetry. See for instance WO 9721090 (Gamera Bioscience), WO 9807019 (Gamera Bioscience) WO 9853311 (Gamera Bioscience), WO 9955827 (Gyros AB), WO 9958245 (Gyros AB), WO 0025921 (Gyros AB), WO 0040750 (Gyros AB), WO 0056808 (Gyros AB), WO 0062042 (Gyros AB), WO 0102737 (Gyros AB), WO 0146465 (Gyros AB), WO 0147637, (Gyros AB), WO 0154810 (Gyros AB), WO 0147638 (Gyros AB), WO 02074438 (Gyros AB), WO 02075312 (Gyros AB), WO 02075775 (Gyros AB), and WO 02075776 (Gyros AB), all of which hereby are incorporated by reference.

The number (plurality) of microchannel structures on a device is typically ≧10, such as≧25 or≧50 or≧90 or≧180 or≧270. An upper limit may be 2000 or 3000. These ranges typically apply to devices in which the microchannel structures are placed on an area corresponding to the area of devices as specified in the next paragraph.

The size of circular devices and other devices having an axis of symmetry discussed herein typically have radii in the interval 10% up to 500% of the radii of a conventional CD. The conventional CD radius is the preferred size.

Two or more microchannel structure may be linked to each other via a common distribution channel with a common inlet in order to be able to dispense one liquid simultaneously to several microchannel structures. One or more microchannel structure may also have a common waste channel system.

Typically one run of a test protocol is performed for each microchannel structure.

The microchannel structures are in the microformat by which is meant that each of them in have at least one cross-sectional dimension that is ≦10³ or ≦10² or ≦10¹ μm. These ranges in particular apply to one or more functional parts, for instance selected amongst volume-defining microcavities, mixing microcavities, detection microcavities, reaction microcavities, etc. The volumes of the aliquots are typically in the μl-format including the nl-format. μl-format is ≦1000 μl, such as ≦100 μl or ≦10 μl and nl-format is ≦1000 nl, such as ≦100 nl or ≦10 nl.

A suitable microfluidic device may be manufactured by first forming a substrate which comprises a surface with a plurality of uncovered microchannel structures that in a subsequent step are covered by another planar substrate (lid). See WO 9116966 (Pharmacia Biotech AB) and WO 0154810 (Gyros AB). At least one of the substrates may be transparent, e.g. the second substrate (lid). At least one of the substrates may comprise a plastic material, e.g. a polymeric material.

The microstructures in the planar substrate are preferably made by replication from a master matrix comprising the inverse of the uncovered microchannel structures. The inverse of the home mark structure (reference mark) may also be included in the master matrix. The master matrix in turn may have been obtained from a master comprising a microstructure, which is the inverse to the microstructure of the master matrix.

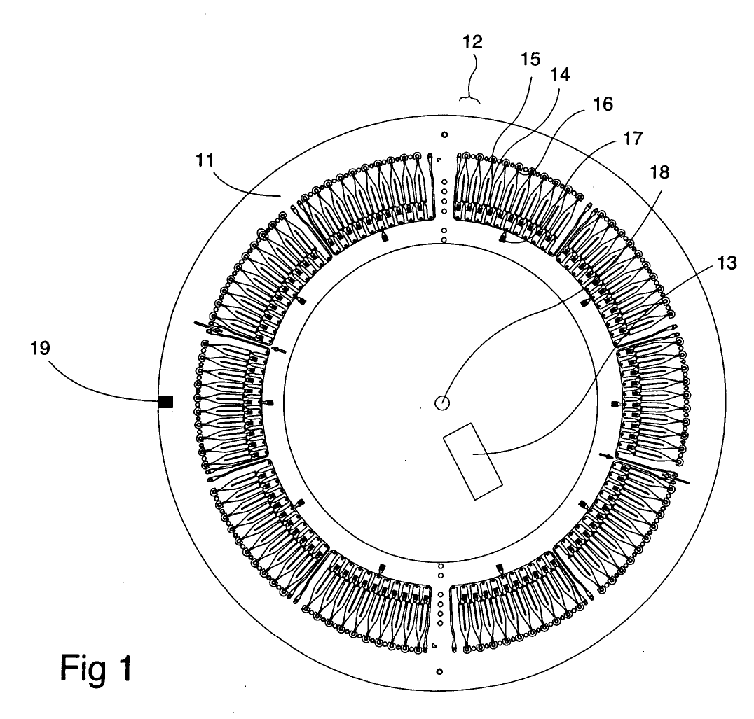

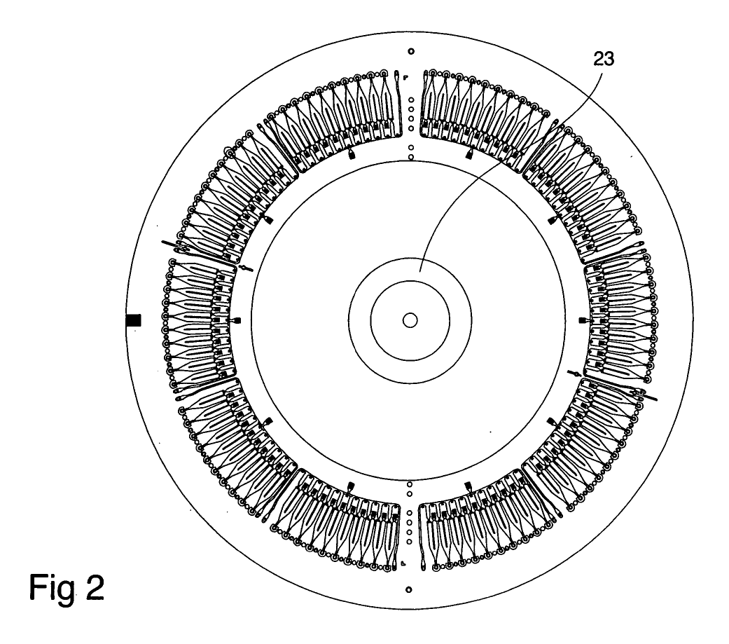

The memory including accessories, if any, is typically placed on a central part of the device. In this context, the accessories include for instance microprocessors, antennas and any other means that may be necessary for receiving/sending information by the communication means used. For rotatable (spin-able) devices, the memory may be placed close to the spinning axis and/or closer to the circumference. The memory plus accessories may occupy an area that is quadric, rectangular, star-formed, noodle-formed, annular, etc. For rotatable substrates, the area may be an annular ring/zone around the spinning axis. See FIGS. 1-2. The memory may be placed on the same side of the device as the inlet/outlet ports, or on the opposite side. The sender/receiver for sending/receiving information to/from the device is located close to the device within the instrument. A general rule for the location of the memory plus accessories is that this function shall not negatively affect the other functions of the device and vice versa.

In specific embodiments, the preferred memory is a transponder, which is placed on a central part of the disc, preferably on the same side as or the side opposite to the inlet/outlet ports and the detection areas. In particular with the memory at a central part, it becomes important to select a side to fit the design of the disc holder that typically acts on a central part.

A second aspect of the invention is a microfluidic device, which comprises a plurality of microchannel structures. The main characteristic feature is that at most 50% of the microchannel structures are excess structures not intended to be used, i.e., the device has a redundancy that is≦50%. In preferred variants, the device is combined with information that gives the position coordinates for the redundant and/or the non-redundant microchannel structures. Position coordinates in this context means information that allows proper dispensation of liquid and the like to inlet ports, detection in detection microcavities, etc.

The information may be placed on the device in a memory as discussed above. Alternatively, the information may be placed in a memory separate to the device, for instance selected amongst the same kind as described above, or in a note on the label of the device or in an accompanying manual. By the term “information” in this context is also meant a direct or an indirect reference to a source from which the full information can be obtained, for instance a reference number that can be used to get the information from the manufacturer. This kind of information is preferably contained within the same package as the microfluidic device.

The second aspect of the invention may comprise the various features and combination of features that are described for the first aspect, for instance a suitable reference mark that for a spinnable device may be located to a spinning part as discussed above.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1-16. (canceled)

17. A microfluidic device comprising a plurality of microchannel structures having a redundancy that is ≦50% and information that gives the position of redundant or non-redundant microchannel structures.

18. The microfluidic device of claim 17, wherein the information is placed in a memory on the device.

19. The microfluidic device of claim 17, wherein the information is separate from the device.

20. The microfluidic device of clam 17, wherein the number of disapproved microchannel structures is≦the number of redundant microchannel structures.

21-25. (canceled)

26. A microfluidic device comprising a plurality of microchannel structures and memory, wherein the memory comprises at least one of:
(a) information about the positions of at least one of:
(i) non-redundant microchannel structures or redundant microchannel structures; and
(ii) approved or disapproved microchannel structures;
(b) information relating to positions for interfacing the microchannel structures with the macroworld; and
(c) supplemental information relating to process protocols that are allowed for the microchannel structures.
